(19) United States
(12) Patent Application Publication
(10) Pub. No.: US 2002/0022899 A1
(43) Pub. Date: Feb. 21, 2002

(54) Control method and system for a computerized logging of data for maintenance of plant facilities and other functions

(75) Inventor: Kurt Deby, Scoresby (AU)

Correspondence Address: Edwin D. Schindler, Five Hirsch Avenue, P. O. Box 966, Coram, NY, 11727-0966, US

(73) Assignee: Total Plant Control Australasia Pty. Limited, Scoresby (AU)

(21) Appl. No.: 09/963,276

(22) Filed: Sep. 26, 2001

Related U.S. Application Data
(63) Continuation of application No. 09/180,736, filed on Nov. 12, 1998.
Application No. 09/180,736 is a 371 of international application No. PCT/AU98/00153, filed on Mar. 12, 1998.

(30) Foreign Application Priority Data
Mar. 12, 1997 (AU) PO 5623/97

(51) Int. Cl. G06F 19/00; G06F 7/00; G06F 17/00

(52) U.S. Cl. 700/100; 700/99; 705/9; 707/102

(57) ABSTRACT

A control system to monitor and maintain various operations, which can include plant maintenance operations, including having a computerized database of the operations to be monitored, providing a data-logger onto which can be downloaded the required operations, selected in any required way, means on the data-logger to indicate that the operation has been effected, and means whereby the records on the data-logger can be uploaded to the computer to update the records thereon. There is also provided a data-logger for use with such an system.

This invention relates to a control method and system and, in particular, to a data logging system. The system can have a wide variety of applications, such as in the control of plant maintenance and lubrication, which is the application which will be fully described, but also in any area where a number of functions or applications have to be effected.

In plant maintenance and lubrication there can be a large number of jobs which have to be done at intervals, and often different intervals. Some of them may be basically very simple, such as simply examining a machine or operation. Some may be more complex, such as greasing nipples or changing or replenishing oils, and others of which may necessitate major operations such as shutting down and reconditioning plants.

All businesses which operate their plant and equipment properly have means whereby the technicians or service people can be informed of the jobs which must be done, and when they must be done. These may simply be workshop manuals which list the times and the jobs. They may include computer programs which have a database of the job from which material is gathered for the individual serviceman.

It has normally been necessary to take the information from the source, to provide this in a form that is used by the serviceman and, after the job has been completed, to update the basic records. This has conventionally been done by printing out for a serviceman a worksheet for the serviceman to effect the jobs on the sheet, for the sheet to go back to the source and for the database to be then updated. Properly executed, such an arrangement ensures that the correct servicing is carried out at the correct time, but it is time consuming and requires the use of paper material, both for the poison ordering the servicing and the serviceman.

In some applications, the records are automatically updated when the serviceman is instructed to do the jobs, and this is of course most undesirable in that if, for some reason, a job is not done, there is never any way to check this other than the serviceman specifically noting that for some reason it was not done.

It is the object of the present invention to provide a system which overcomes the shortcomings of previous systems and which enables the control of maintenance to be effected substantially automatically and to ensure that where specific maintenance jobs have not been done, this is identified by both the technician and the controller.

The invention in its broadest sense comprises a control system to monitor and maintain various operations which includes having a computerised database of the operations to be monitored, providing a data-logger onto which can be downloaded required operations, selected in any required way, means on the data-logger to indicate that the operation has been effected, and means whereby the amended records on the data-logger can be re-transmitted to the computer to update the records thereon.

In a specific application, we provide a control system to monitor the effecting of various aspects of plant maintenance which includes having a computerised database of maintenance jobs, providing a data-logger onto which can be downloaded jobs, selected in any required way, means on the data-logger to indicate that the job has been effected, and means whereby the records on the data-logger can be re-fed to the computer to update the records thereon.

It is preferred that the serviceman's data-logger is provided with means whereby it can obtain a signal from the machine or item being serviced so that there is notional confirmation the service has been effected.

It is preferred that there is a counter which displays the total number of jobs remaining to be done.

The invention also relates to a data-logger for use with such a system.

In order that the invention way be more readily understood and put into practice, reference shall be made to the accompanying drawings which describe a certain form of the invention.

In these drawings:

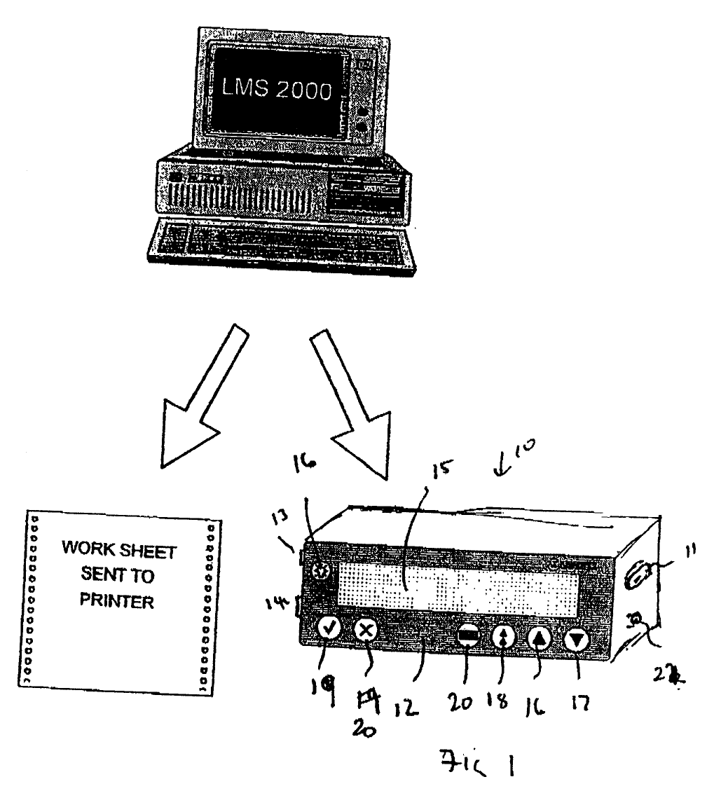

FIG. 1 Comprises a perspective view of the data-logger of the invention.

The description will be on the basis of a plant maintenance system, though it is to be understood that it is by no means limited to this; it can have equal application in any other area where predetermined actions may be taken, even to such things as a delivery system or the like. It will be appreciated than in some of the applications certain features described would not be necessary and in other applications, it would be possible to provide different functions which would be desiderata in the applications concerned.

As mentioned previously, there is on a computer a database of various functions which have to be effected. This database will normally include a number of fields of information and, in one form, these could include the item number given to the equipment, the components which need to be serviced and the frequency of such service.

The database could also include further information such as the type of lubricant to be used in the service or the part number of a part which needs to be replaced, so that the technician can have this in his hand, which will be explained later.

The database will also incorporate a field indicating the particular technician or the particular position which does the required action on the required article.

It may also be preferred that the information on the database includes an indication of an identifying feature on a particular part of the particular equipment.

There are two ways of providing this identifying feature: one, by providing a bar-code adjacent the requisite point, or the other by providing a means which itself provides a particular indication. One such means are the so called “Dallas Touch” indicators which are passive electronic devices which ale actuated by an external current and which leave a unique code which can be turned into a number.

The invention includes, in association with the databases, a data-logger 10 which may itself be a computer, having a pre-determined amount of Random Access Memory and a CPU.

The data-logger's input can be of three forms. The first of these may be a standard RS232, some other port or an infra-red data connection means or a modem based connection, the port being arranged to permit downloading of material from the computer carrying the database and uploading material thereto after use of the data-logger. The second can consist of number of switches or touch members on the face 12 thereof to effect various operations. The third a Dallas Touch indicator reader or a bar code reader 13. Associated with the Dallas Touch reader or the bar-code reader there can be a port 14 to which an extension reader can be connected to permit information to be obtained.

The data-logger can have an LCD screen 15 which, in one application, could be forty characters by four lines in size, has an internal power source for its operation. It has a real time clock to verify each completed job with a time and date stamp.

It may be provided with a switch 16 and this can also be used to indicate battery charge and that it is operative and this may be either part of or associated with a switch which can provide a back light for the screen in low ambient light conditions. Also, the data-logger may have a sleep mode which comes into operation after a predetermined time during which no action has been taken and it can be brought back into full operation by actuating the back light switch.

In the particular embodiment, the face 12 may have six other input buttons or the like. Two of these 16,17 may be up and down keys which moves the display of the data-logger from position to position. A third 18 may be a proceed to next not done job key which may also be used to cycle through the not done jobs. Another 9 may be a key which indicates that a particular function has been done or confirm a situation. Another 20 that a job has not been done or is incomplete, although the normal state of the device is not done so this would only have to be used where there was originally an indication that the job had been done (undo function) or it can be used as the basis of the entry of particular messages.

The last 20 can be a numeric input which may also be used to provide a coded message for later uploading. This can also have associated thereabouts a battery condition indicator. There is also provided an input 22 for a battery charger to maintain the internal battery. To understand the operation of the data-logging device, it will be simplest to simply describe what occurs under various circumstances.

Firstly, at the beginning of a period, say, a day or a week, the data-logger is connected to the computer having the database, and all matters which have to be attended to by the particular person during a predetermined lime are downloaded into the data-logger. This then gives the technician, or other person, who will be referred to as a technician, a complete listing of all the jobs that need to be done during the period. The number of jobs can be displayed on the data-logger display.

Referring to the display, this is preferably so programmed that required information can be placed at any required position on the display, and depending on the application so different information can be used, or the relative importance, and thus the positioning on the display can vary.

Generally, the jobs can either be done in order or in any order required by the technician, with the proviso that should any of the jobs be coded as urgent, such as critical job being overdue they will come up on the data-logger first, and it may be that until such job(s) have been completed, other jobs cannot be displayed.

The display will come up with an indication of the machine and either the jobs to be done on the machine, or the first job to be done on the machine.

The job would also have an indication of the material or materials to be used or the part to be replaced.

The technician will then complete this job and on completion, press the Completed button 18.

If, for some reason, the job cannot be completed, he does not press the complete button, and the data-logger holds the job as outstanding. Alternatively, if there is a necessity to provide details of why the job could not be completed he could press the incomplete button 19 and enter a code, preferably from the numeric key to indicate the reason for non-completion.

He can then move forwardly to the next listed job on that machine, if there is one or onto the next job on another machine. This action can be continued until all of the jobs are complete. At any time, the technician can maintain a check on all jobs, completed, non-completed or not done jobs.

Using the preferred form of data-logger, if, say, a gearbox took a certain number of liters of oil, he can use the numeric input button, possibly in association with the up and down keys or some other arrangement to record the quantity of material which was used or added.

As each job is indicated to have been completed, the time and date of completion is entered onto the record automatically.

Once the jobs have all been completed or completed as far as possible, then the technician can either take the data-logger to the person in control of the database or can connect the data-logger to the database in any of the methods mentioned before, the information in the data-logger uploaded to the database and, if required, a further set of jobs downloaded into the data-logger.

During the uploading, the database will be automatically updated where required, win flag the necessity of further actions where these have not been completed, and cause a note of a possible fault condition such as any abnormal temperature in any area where temperature is monitored, as will be described later herein so that remedial action can be taken.

As is conventional, at any time the database can be accessed and, say, a full print-out of maintenance history of any particular item, or indeed, all items, can be obtained.

We earlier indicated that the database could incorporate the numbers of Dallas Touch devices or bar-codes associated with a piece of equipment or part thereof to provide an indication of some parameter associated with the equipment.

If these are to be used, the user of the data-logger makes use of the input 13 or its associated input 14 provide either an actuating device for the Dallas devices, or a bar-code reader.

In the simplest case, this necessitates the data-logger to be in close proximity to the particular piece of equipment, and so whilst a requirement to read the bar-code or actuate the Dallas Touch device does not ensure that the associated function has been done, it does mean that the technician is where he should be to effect the function, so the likelihood of omitting the function becomes very small.

This can be taken further in that the software controlling the data-logger can be set-up so that the technician cannot enter that the job as being completed until he initiates operation of the Dallas Touch Device or read the bar-code.

The data-logger can be so set up that if the bar code or the Dallas Touch device is read, this will automatically bring up the required action on the data-logger so that the technician is directly lead to what has to be done to satisfy the requirements of the particular code or device. This message can be removed from the screen of the data-logger wither by the keying of the fact that the job has been completed or in any other required operation.

If Dallas Touch devices are used, there can be additional functions which can be effected.

Firstly, one form of the device is arranged to provide a temperature reading in its output. Thus, particularly around moving parts where a variation in temperature may indicate insufficient lubrication or a mechanical fault in a part, such as a bearing, the technician can be warned. It is possible to set up an acceptable range of temperatures for the part and if the temperature is outside this range, when the Dallas Touch device is interrogated, a fault situation will be noted. Also, the temperature can be recorded so that there is a history of the temperature maintained.

In a further form of Dallas Touch device the device is not passive and includes a memory. This can be sufficient to hold a number of pages of text so that the device can be used either to maintain a record of matters of importance or can hold the necessary parts of a workshop manual to guide the technician in performing his duties.

The numeric input can be provided with a number of codes which are associated with a particular input. In this way the technician can, by entering a required code, and the corresponding message can be displayed for confirmation on the LCD display screen on the number being entered and this message will be uploaded to the computer having the data base.

It is preferred that the data-logger is encased in a way to give protection when it is being used in a plant and this may include an outer casing or cover which is of shock-absorbing material.

Whilst we have described herein various aspects of the invention and its application, it will be understood that these can vary widely depending on the particular use to which the invention is being put, and as such, the fields maintaining the main database can be changed and the number of these can be varied, the particular form of the data-logger can be modified and all such variations and modifications have been included within the scope of the invention.

The claims defining the invention are as follows:

1. A control system to monitor and maintain various operations which includes having a computerised database of the operations to be monitored, providing a data-logger onto which can be downloaded required operations, selected in any required way, means on the data-logger to indicate that the operation has been effected, and means whereby the amended records on the data-logger can be re-transmitted to the computer to update the records thereon.

2. A control system as claimed in claim 1 for effecting various aspects of plant maintenance which includes having a computerised database of maintenance jobs, providing a data-logger onto which can be downloaded jobs, selected in any required way, means on the data-logger to indicate that the job has been effected, and means whereby the records on the data-logger can be re-fed to the computer to update the records thereon.

3. A control system as claimed in either claim 1 or claim 2 wherein the data-logger is provided with means whereby it can obtain a signal from the machine or item being serviced, which is recorded thereon so that there is notional confirmation the service has been effected.

4. A control system as claimed in any preceding claim wherein the data-logger includes a counter which indicates the number of jobs or operations loaded into the data-logger.

5. A system as claimed in any preceding claim wherein if operations have not been completed or if there is any indication of fault, these are brought to the attention of the operator when the information from the data-logger is down loaded into the computer.

6. A data-logger for a control system as claimed in any one of the preceding claims including means to receive information from a computer, which information includes details of operations to be performed, means to display the operations, means to permit an input as to the completion of the operation and means to return the information carried by the data-logger to a computer.

7. A data-logger as claimed in claim 6 having means to input various information about individual operations.

8. A data-logger as claimed in claim 6 or claim 7 including means whereby identification of parameters relating to the function can be obtained.

9. A data-logger as claimed in claim 8 wherein the means to identify parameters includes a reader for a Dallas Touch device which can passively or actively include information about the device or its environment.

10. A data-logger as claimed claim 8 wherein the means to identify a parameter includes a bar-code reader which can obtain information about the operation from a bar-code associated with the operation.

11. A data-logger as claimed in any one of claims 8 to 10 wherein the data-logger includes input means for an external reading device.

12. A data-logger as claimed in any one of claims 6 to 11 wherein the data-logger is self contained and located in a casing which is adapted to be carried by a user.

13. A data-logger as claimed in claim 12 herein the casing has a resilient surround to provide protection for the data-logger when used in the field.

14. A data-logger as claimed in either claim 12 or claim 13 wherein the data-logger includes a rechargeable battery to provide the necessary power.

15. A data-logger as claimed in any one of claims 12 to 14 wherein the data-logger display is provided by a LCD screen.

16. A data-logger as claimed, in any one of claims 12 to 15 wherein the means whereby an operator enters information into the data-logger comprise touch switches or the like.

17. A control system to monitor and maintain various operations substantially as hereinbefore described with reference to the accompanying drawings.

18. A data-logger for use with a control system to monitor and maintain various operations substantially as hereinbefore described with reference to the accompanying drawings.
